(19) United States
(12) Patent Application Publication
(10) Pub. No.: US 2008/0272700 A1
(43) Pub. Date: Nov. 6, 2008

(54) PLASMA GENERATING DEVICE

(75) Inventors: Jui-Yu LIN, Taoyuan Hsien (TW); Chwung-Shan KOU, Taoyuan Hsien (TW); Teng-Wei WANG, Taoyuan Hsien (TW); Yan-Ru PAN, Taoyuan Hsien (TW); Tzu-Ching CHANG, Taoyuan Hsien (TW); Chih-Chieh YU, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/939,642

(22) Filed: Nov. 14, 2007

(30) Foreign Application Priority Data
May 1, 2007 (TW) 096115501

(51) Int. Cl. H05H 1/00

(52) U.S. Cl. 315/111.21

(57) ABSTRACT

In the present invention, a plasma generating device is provided for generating a plasma with a uniform intensity. The plasma generating device comprises at least a first antenna to transmit the first electromagnetic wave, at least a second antenna to transmit the second electromagnetic wave, and an insulator defining an isolated space for containing therein the first antenna and the second antenna, wherein the first antenna has an opposite orientation with respect to the second antenna, so that the first electromagnetic wave and the second electromagnetic wave are transmitted in opposite directions. The first and the second electromagnetic waves can be coupled with each other to produce a uniform standing wave pattern. Consequently, a large size uniform plasma can be generated.

### FIELD OF THE INVENTION

The present invention relates to a plasma generating device. More particularly, the present invention relates to a plasma generating device utilizing electromagnetic waves.

### BACKGROUND OF THE INVENTION

Plasmas are widely applied in industry and have become major equipments for etching, ashing and deposition in the fabrication process of semiconductors and TFT-LCD. Additionally, the plasma is used to enhance the chemical vapor deposition process of the silicon nitride layer, the amorphous silicon layer, the microcrystalline layer, the silicon dioxide layer, the diamond layer, the diamond-like layer and the carbon nanotube. Besides, plasmas are also used for the surface processing process, like the rainproof and moisture release cloth.

Plasmas can be excited by electrical powers with different frequencies, including the DC discharge, the low and medium radio frequency discharge, and microwave discharge technologies. The frequency used in the low and medium band is ranged from KHz to several MHz. The microwave discharge method uses the 2.45 GHz frequency. Since the required equipments are relatively simple and easy, the microwave discharge method is very promising.

In the microwave discharge method for generating the plasma, owing to the relative shorter wave length of the microwave, the dimensions of the operating chamber for accommodating large size substrates to be processed should be several times larger than the wave length of the microwave. Beside, the microwave penetration length into plasma is small. Consequently, it's difficult to make the plasma source with a large uniform area. In previous inventions, US20040011466 discloses a plasma processing apparatus which can generate a high-density plasma with a high efficiency. DE19503205C1 discloses a technical scheme where a high density plasma can be generated. Despite the advanced technologies provided in the prior art, it is found that the uniformity of the microwave plasma with the large area is still an issue.

In order to overcome the drawbacks in the prior art, a plasma generating device is proposed through arduous experiments and research.

### SUMMARY OF THE INVENTION

It is a first aspect of the present invention to provide a plasma generating device for generating a plasma.

It is a second aspect of the present invention to provide a plasma generating device for generating a plasma with a uniform intensity.

It is a third aspect of the present invention to provide a plasma generating device to processing a substrate, wherein the plasma generating device comprises a first antenna to transmit the first electromagnetic wave and at least a second antenna to transmit the second electromagnetic wave, wherein the first electromagnetic wave and the second electromagnetic wave are transmitted in opposite directions, and the first electromagnetic wave is coupled with the second electromagnetic wave in an overlapping area between the first antenna and the second antenna.

It is a fourth aspect to provide a plasma generating device for generating a uniform plasma, wherein the plasma generating device comprises an electromagnetic wave shield with at least an opening and an antenna to transmit an electromagnetic wave, wherein the antenna is installed inside the electromagnetic wave shield.

It is a fifth aspect of the present invention to provide a plasma generating device for generating a plasma with a uniform intensity, the plasma generating device comprises a first antenna to transmit the first electromagnetic wave, and a second antenna to transmit the second electromagnetic wave, wherein the first electromagnetic wave and the second electromagnetic wave are transmitted in opposite directions. In addition, an insulator forms an isolated space for accommodating the first and the second antennas, wherein the first and the second electromagnetic waves are coupled with each other to produce a more uniform standing form pattern. Under this condition, a uniform plasma can be excited.

It is a sixth aspect of the present invention to provide a plasma generating device for generating a plasma with a uniform density to grow a film on a substrate in a processing chamber. The plasma generating device comprises a first antenna to transmit the first electromagnetic wave, and a second antenna to transmit the second electromagnetic wave, wherein the first electromagnetic wave and the second electromagnetic wave are transmitted in opposite directions. In addition, an insulator forms an isolated space for accommodating the first and the second antennas, wherein the first and the second electromagnetic waves are coupled with each other to produce a more uniform standing form pattern. Under this condition, a uniform plasma can be excited.

Other objects, advantages and efficacies of the present invention will be described in detail below taken from the preferred embodiments with reference to the accompanying drawings, in which:

### BRIEF DESCRIPTION OF THE DRAWINGS

FIG. 1 is a perspective diagram showing the plasma generating device according to a preferred embodiment in the present invention;

FIG. 2 is a perspective diagram showing the plasma generating device according to a preferred embodiment in the present invention;

FIG. 3 is a perspective diagram showing the plasma generating device according to a preferred embodiment in the present invention;

FIG. 4 is a diagram showing the antenna structure of the plasma generating device according to a preferred embodiment in the present invention;

FIG. 5 is a diagram showing the antenna structure of the plasma generating device according to a preferred embodiment in the present invention; and

FIG. 6 is a diagram showing the antenna structure of the plasma generating device according to a preferred embodiment in the present invention.

### DETAILED DESCRIPTION OF THE PREFERRED EMBODIMENT

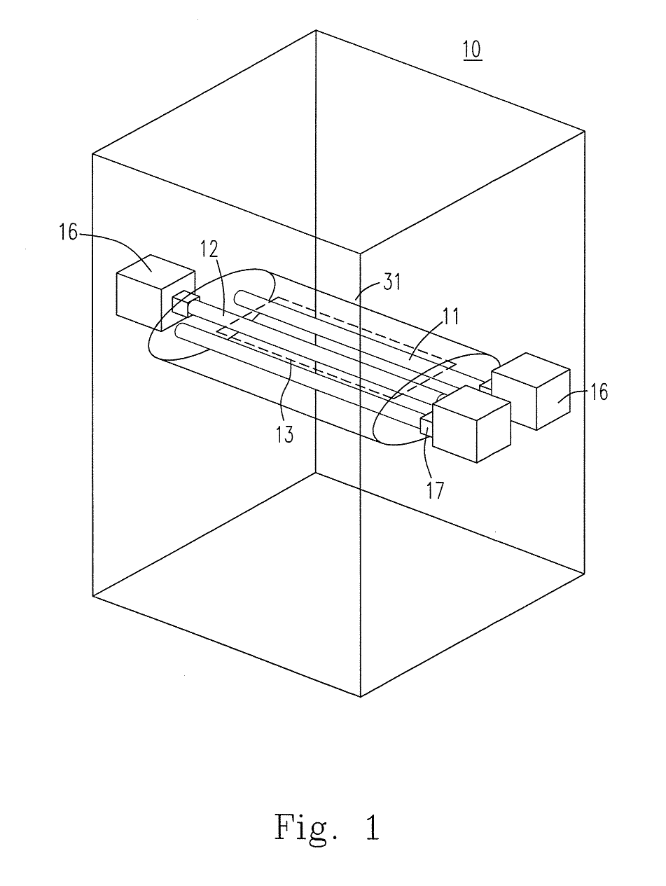

Please refer to FIG. 1, which is the plasma generating device according to a preferred embodiment in the present invention. The plasma generating device 10 includes an antenna module 31 for generating a plasma, wherein the antenna module 31 includes a first antenna 11 for transmitting a first electromagnetic wave and a second antenna 12 for transmitting a second electromagnetic wave, wherein the first antenna has an opposite orientation with respect to the second antenna, so that the first electromagnetic wave and the second electromagnetic wave are transmitted in opposite directions. Furthermore, the first and the second electromagnetic waves are supplied from electromagnetic wave generators 16 and input into the first antenna 11 and the second antenna 12 through electromagnetic wave couplers 17, respectively. Additionally, the first antenna 11 and the second antenna 12 are configured in the way that they are of the same length and parallel to each other with a distance therebetween. Correspondingly, when the first electromagnetic wave is coupled with the second electromagnetic wave in an overlapping area 13 between the first antenna 11 and the second antenna 12, a standing wave can be created. The peak amplitude of the standing wave can be uniform as the distance and the amplitude of each wave are properly chosen. Consequently, a uniform plasma can be generated.

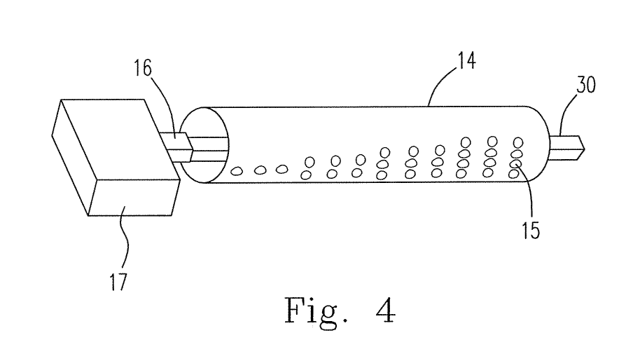

According to the various necessities resulting from the applications for the plasma generating device 10, the first antenna 11 and the second antenna 12 of the antenna module 31 manage to be set up in different arrangements. As shown in FIG. 4, it is preferably that at least one of the first antenna 11 and the second antenna 12 is a conducting rod 30 located in an electromagnetic wave shield 14 with at least an opening 15, wherein the number of the openings 15 are designed to vary along the longitudinal axis of the conducting rod 30 from the input terminal thereof, so that a total area of the openings 15 per length of the electromagnetic wave shield 14 is changeable, whereby a electromagnetic wave magnitude along the longitudinal axis of the conducting rod 30 is adjustable to generate the plasma with a uniform intensity.

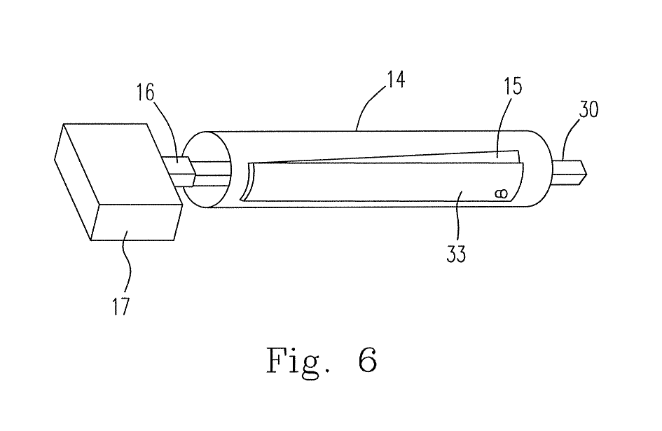

As shown in FIG. 6, the present invention is further characterized in that the electromagnetic wave shield 14 has a shield device 33 for covering an area of the opening 15, wherein the shield device 33 is configured to be controlled by an external device for being moved with respect to the electromagnetic wave shield 14, so that a size of the area of the opening 15 is controllable, whereby the intensity of the plasma generated by the plasma generating device 10 is varied.

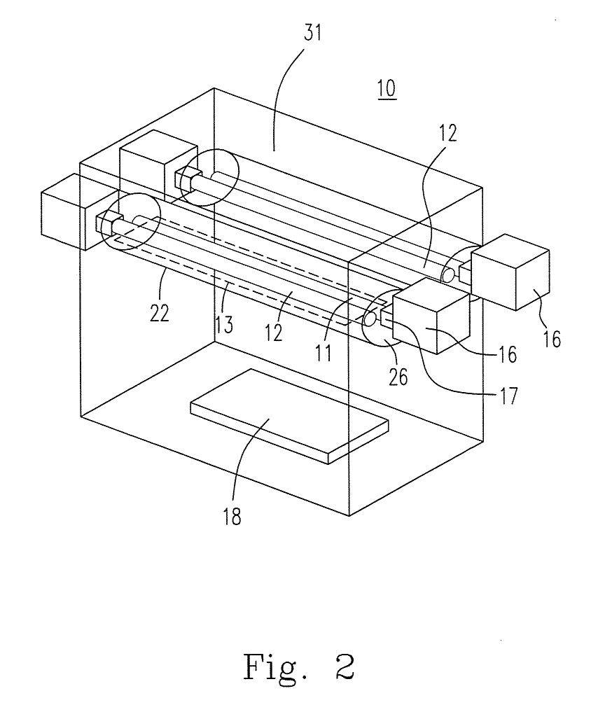

Please refer to FIG. 2, which is the plasma generating device according to a preferred embodiment of the present invention. The plasma generating device 10 includes an antenna module 31 for generating a plasma to process a substrate 18, wherein the antenna module 31 includes a first antenna 11 for transmitting a first electromagnetic wave and a second antenna 12 for transmitting a second electromagnetic wave, wherein the first electromagnetic wave is coupled with the second electromagnetic wave in an overlapping area 13 between the first antenna 11 and the second antenna 12, so that the plasma is generated with a uniform intensity with respect to the overlapping area 13. On the other hand, for protecting the first antenna 11 and the second antenna 12 from the plasma, it is preferably that the first antenna 11 and the second antenna 12 are disposed in an isolated space 26 defined by an insulator 22, wherein there is a cooling fluid contained in the isolated space 26 for controlling a temperature therein.

According to the various necessities resulting from the applications for the plasma generating device 10, the first antenna 11 and the second antenna 12 of the antenna module 31 manage to be set up in different arrangements, wherein it is preferably that the first antenna 11 has an opposite orientation with respect to the second antenna 12, and there is another insulator 22 containing the second antenna 12 to be a third antenna adjacent to the first antenna 11, wherein the antennas adjacent to each other are orientated opposite mutually.

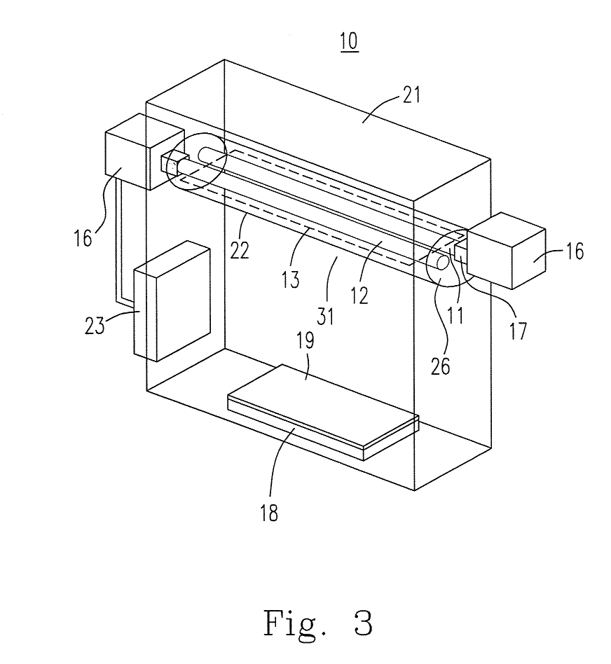

Please refer to FIG. 3, which is the plasma generating device according to a preferred embodiment in the present invention. The plasma generating device 10 includes at least an antenna module 31 disposed in a processing chamber 21 for generating a plasma to form a film 19 on a substrate 18, wherein the antenna module 31 has a first antenna 11 for transmitting a first electromagnetic wave and a second antenna 12 for transmitting a second electromagnetic wave. Furthermore, the first electromagnetic wave is coupled with the second electromagnetic wave in an overlapping area 13 between the first antenna 11 and the second antenna 12, so that the plasma is generated with a uniform intensity with respect to the overlapping area 13. For protecting the first antenna 11 and the second antenna 12 from the plasma, it is preferably that the first antenna 11 and the second antenna 12 are disposed in an isolated space 26 defined by an insulator 22, wherein the isolated space 26 defined by the insulator 22 is positioned passing through the processing chamber 21 and two ends of the isolated space 26 are sealed by a wall of the processing chamber 21, wherein a profile of the isolated space 26 perpendicular to the axis of the respective antenna is one of a circular shape and a polygon.

Specifically, the first electromagnetic wave and the second electromagnetic waves are generated by an electromagnetic wave generator 16 and through an electromagnetic wave coupler 17 input into the first antenna 11 and the second antenna 12, respectively, wherein a frequency parameter, a power parameter and an ON/OFF state parameter of the electromagnetic wave generator 16 are adjustable, respectively, so as to adjust a magnitude of the respective electromagnetic wave. The present invention is also characterized in that the plasma generating device 10 further comprises an optic-electro sensor 23 controlling the electromagnetic wave generator 16 synchronously based on a development of the film 19 with respect to the substrate 18, wherein the development relates to one of a uniformity and a thickness of the film 19.

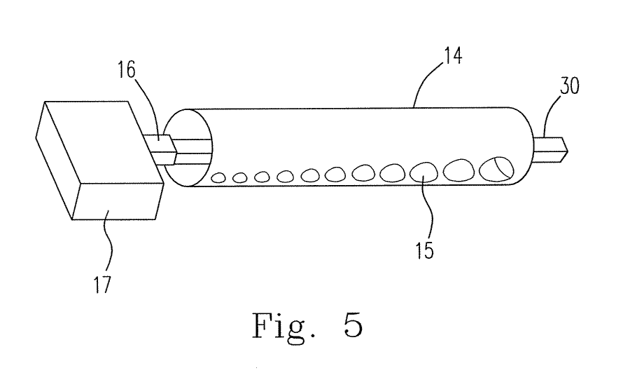

According to the various necessities resulting from the applications for the plasma generating device 10, the first antenna 11 and the second antenna 12 of the antenna module 31 manage to be set up in different arrangements. As shown in FIG. 5, it is preferably that at least one of the first antenna 11 and the second antenna 12 is a conducting rod 30 disposed in an electromagnetic wave shield 14, wherein there are a plurality of openings 15 on a side of the electromagnetic wave 14 adjacent to the film 19. Specifically, a diameter of the opening 15 is varied along the longitudinal axis of the conducting rod 30 from an input terminal thereof, so that an electromagnetic wave magnitude is controlled along the longitudinal axis of the conducting rod 30 and the first electromagnetic wave and the second electromagnetic wave are effectively coupled with each other within the overlapping area 13

To summarize, the present invention proposes a plasma generating device for processing a substrate, wherein a plasma with a uniform intensity is generated within an overlapping area between the first antenna and the second antenna, so that the drawbacks where electromagnetic waves are reflected by the previously formed plasma and the subsequent plasma is generated without a uniform intensity in the prior art are overcome.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A plasma generating device for generating a plasma, comprising:
at least a first antenna transmitting a first electromagnetic wave; and
at least a second antenna transmitting a second electromagnetic wave, wherein the first electromagnetic wave is coupled with the second electromagnetic wave in an overlapping area between the first antenna and the second antenna for generating the plasma.

2. A plasma generating device as claimed in claim 1, wherein the plasma generated is corresponding to the overlapping area, and has a uniform intensity.

3. A plasma generating device as claimed in claim 1, wherein the first and the second antennas with a distance therebetween are of the same length and parallel to each other.

4. A plasma generating device as claimed in claim 1, wherein the respective antenna is electrically connected to an electromagnetic wave generator via an electromagnetic wave coupler.

5. A plasma generating device as claimed in claim 1, wherein at least one of the first and the second antenna is a conducting rod.

6. A plasma generating device for generating a plasma with a uniform intensity, comprising:
an electromagnetic wave shield with at least an opening; and
an antenna for transmitting an electromagnetic wave, wherein the antenna is disposed in the electromagnetic wave shield.

7. A plasma generating device as claimed in claim 6, wherein the antenna is a conducting rod and a magnitude of the electromagnetic wave along the conducting rod is adjusted by the opening.

8. A plasma generating device as claimed in claim 6, wherein the electromagnetic wave shield has a shield device for covering an area of the opening, wherein the shield device is movable in relation to the electromagnetic wave shield so that a size of the area is controllable.

9. A plasma generating device as claimed in claim 8, wherein the shield device is configured to be controlled by an external device for being moved with respect to the electromagnetic wave shield.

10. A plasma generating device for generating a plasma with a uniform intensity, comprising:
at least a first antenna transmitting a first electromagnetic wave;
at least a second antenna transmitting a second electromagnetic wave; and
an insulator forming an isolated space for accommodating the first and the second antennas;
wherein the first and the second electromagnetic waves are coupled with each other to generate the plasma through the insulator in an overlapping area between the first antenna and the second antenna.

11. A plasma generating device as claimed in claim 10, wherein the first antenna has an opposite orientation with respect to the second antenna.

12. A plasma generating device as claimed in claim 10 further comprising another insulator containing a third antenna adjacent to one of the first antenna and the second antenna, wherein the antennas adjacent to each other are orientated opposite mutually.

13. A plasma generating device as claimed in claim 10, wherein the plasma is used to form a film on a substrate in processing chamber.

14. A plasma generating device for generating a plasma with a uniform intensity to form a film on a substrate in a processing chamber, comprising:
at least a first antenna transmitting a first electromagnetic wave;
at least a second antenna transmitting a second electromagnetic wave; and
an insulator defining an isolated space for containing therein the first antenna and the second antenna;
wherein in an overlapping area between the first antenna and the second antenna, the first and the second electromagnetic waves are coupled with each other to generate the plasma so as to form the film on the substrate.

15. A plasma generating device as claimed in claim 14, wherein the isolated space defined by the insulator is positioned passing through the processing chamber and two ends of the isolated space are sealed by a wall of the processing chamber.

16. A plasma generating device as claimed in claim 14, wherein at least one of the first and the second antennas is a conducting duct disposed in an electromagnetic wave shield with at least an opening, and the respective electromagnetic wave is within the microwave bandwidth.

17. A plasma generating device as claimed in claim 14, wherein an electromagnetic wave generator is electrically connected to the respective antenna via an electromagnetic wave coupler.

18. A plasma generating device as claimed in claim 16, wherein a frequency parameter, a power parameter and an ON/OFF state parameter of the electromagnetic wave generator are adjustable, respectively, so as to adjust a magnitude of the respective electromagnetic wave.

19. A plasma generating device as claimed in claim 18, further comprising an optic-electro sensor controlling the electromagnetic wave generator based on a development of the film.

20. A plasma generating device as claimed in claim 14, wherein a profile of the isolated space perpendicular to the axis of the respective antenna is one of a circular shape and a polygon, and a temperature in the isolated space is decreased by a cooling fluid contained therein.
